(19) United States
(12) Patent Application Publication
(10) Pub. No.: US 2020/0139673 A1
(43) Pub. Date: May 7, 2020

(54) ADHESIVE LAYERS

(71) Applicant: Hewlett-Packard Development Company, L.P., Spring, TX (US)

(72) Inventors: Kenneth Williams, Vancouver, WA (US); Joseph Wayne Zieman, Vancouver, WA (US); Po-Jen Shih, Vancouver, WA (US); Wesley R. Schalk, Vancouver, WA (US); Peter J. Boucher, Vancouver, WA (US)

(73) Assignee: Hewlett-Packard Development Company, L.P., Spring, TX (US)

(21) Appl. No.: 16/616,083

(22) PCT Filed: Jul. 18, 2017
(86) PCT No.: PCT/US2017/042561

§ 371 Date: Nov. 22, 2019

(51) Int. Cl. B32B 7/12; C09J 7/38; C09J 7/35; B32B 17/06

(52) U.S. Cl. CPC B32B 7/12; C09J 7/38; C09J 7/35; B32B 2250/02; C09J 2205/31; B32B 2305/72; B32B 17/064

(57) ABSTRACT

An example device includes a first layer having a first layer surface and a second layer having a second layer surface. A pressure sensitive adhesive is applied to the first layer surface of the first layer, and a curable adhesive is applied to the second layer surface of the second layer. The curable adhesive and the pressure sensitive adhesive are joined to adhere the first layer to the second layer.

### BACKGROUND

In many applications, objects or materials are secured to one another. Depending on various factors, the securing of such objects may be achieved with fasteners or adhesives. For example, for large, bulky components, fasteners (e.g., screws, bolts, etc.) may be used, while smaller, thinner components may be secured via adhesives. In the case of adhesives, any of variety of adhesives may be used depending on the particular application.

### BRIEF DESCRIPTION OF THE DRAWINGS

For a more complete understanding of various examples, reference is now made to the following description taken in connection with the accompanying drawings in which:

FIG. 1 illustrates an example device with adhesive layers;

FIG. 2 illustrates an example apparatus prior to assembly;

FIG. 3 illustrates the example apparatus of FIG. 2 with adhesives applied to corresponding surfaces;

FIG. 4 illustrates the example apparatus of FIGS. 2 and 3 in an assembled state; and

FIG. 5 is a flow chart illustrating an example method for assembling an apparatus.

### DETAILED DESCRIPTION

Various examples described herein relate to adhesion of a glass layer to another layer, such as a molded layer of a frame. A layered adhesion is provided to allow a device to accommodate a range of temperatures without the glass layer cracking. In various examples, a glass layer and a molded layer are adhered using a pressure-sensitive adhesive applied to the surface of the glass layer, which is a generally smooth, flat surface. A curable adhesive is applied to a surface of the molded layer. The surface of the molded layer generally includes imperfections which result in that surface being non-smooth (e.g., not flat or rough). The glass layer and the molded layer are then merged with the pressure sensitive adhesive and the curable adhesive between the glass layer and the molded layer. The curable adhesive has a viscosity that allows the curable adhesive to conform to the pressure sensitive adhesive on one side and the molded layer on the opposing side. Thus, with temperature changes, the pressure sensitive layer provides sufficient shearing to prevent the glass layer from cracking or breaking, as well as preventing the glass layer from separating from the molded layer. The curable adhesive may be UV-curable or heat-curable.

As noted above, adhesives may be used to secure various components. In some cases, the components to be secured may be formed of different materials. For example, in many applications, a glass layer may be secured to a plastic body. In one example, in the case of imaging devices (e.g., printers or scanners), a glass layer may be secured to a housing for use in a contact image sensor. The housing may be formed of a molded plastic or another material that is different from the glass layer. Such arrangements may be exposed to environments with different temperature conditions. In some cases, the temperature ranges may be sufficiently large and the thermal expansion coefficients of the two materials may be sufficiently different to result in warping, separation or cracking of at least one of the two materials. For example, with a sufficient change in the temperature, the different expansion of the molded plastic housing and the glass layer may cause the glass layer to crack or break. Various examples described herein provide for adhesive layers to prevent or reduce the likelihood of such issues, allowing such devices to accommodate a greater range of temperatures.

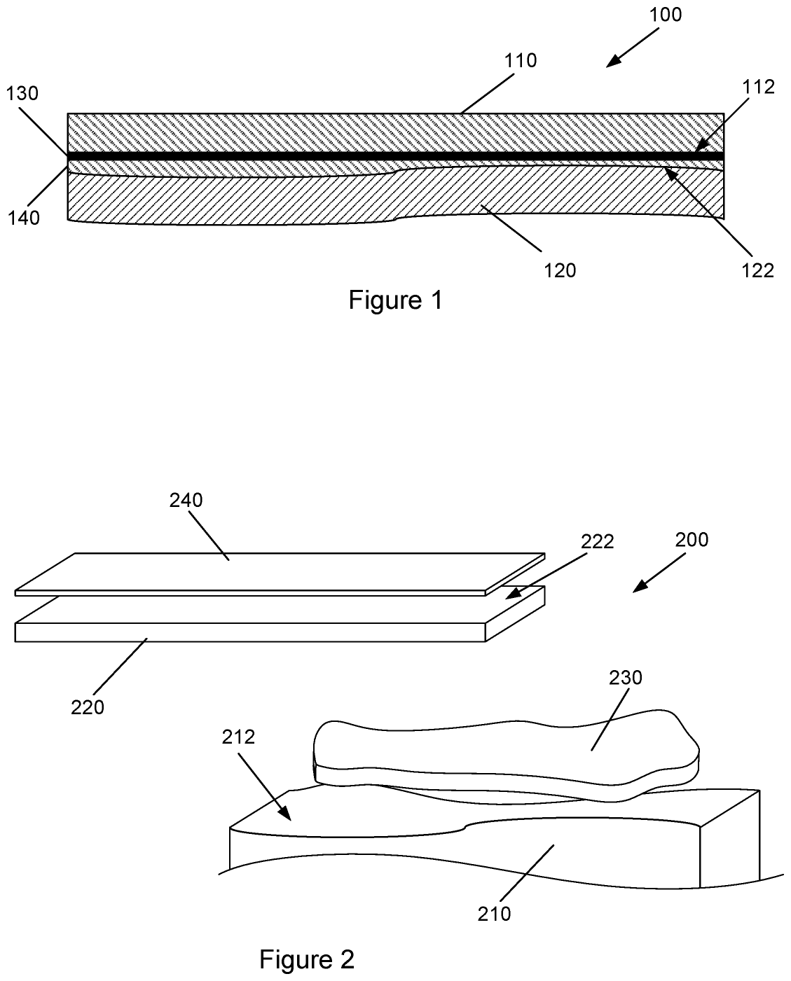

Referring now to the figures, FIG. 1 illustrates an example device 100 with adhesive layers. The example device 100 of FIG. 1 includes a first layer 110 that is adhered to a second layer 120. The first layer has a substantially flat surface 112. In various examples, the first layer 110 may be formed of any of a variety of materials. For example, the first layer 110 may be formed of glass. The thickness of the first layer 110 may be selected as desired for a particular application.

Similarly, the second layer 120 may be formed of any of a variety of materials. In one example, the second layer 120 is formed of a molded plastic. Again, the thickness of the second layer 120 may be selected as desired for the particular application. In one example, the second layer 120 is part of a frame of a larger device, such as an imaging device.

The second layer 120 is provided with a surface 122 to which the first layer 110 is adhered. In some examples, the surface 122 of the second layer may be non-flat. This can reduce the cost in production of the second layer 120 (e.g., the frame of a device), allowing less precision in manufacturing, for example.

In the example device 100 of FIG. 1, the first layer 110 and the second layer 120 are adhered to one another with at least two layers of adhesives. As illustrated in FIG. 1, a pressure sensitive adhesive 130 is applied to the substantially flat surface 112 of the first layer 110, and a curable adhesive 140 is applied to the surface 122 of the second layer 120. The thickness of each adhesive layer may be selected for a desired application. In various examples, the pressure sensitive adhesive 130 has a thickness of between about 0.1 mm and about 0.2 mm, and the curable adhesive 140 has a thickness of between about 0.05 mm and about 0.5 mm. In various examples, the curable adhesive 140 may be an ultraviolet (UV) curable adhesive. In this regard, as described in greater detail below, with the first layer 110, the second layer 120 and the adhesive layers 130, 140 in the desired position, the curable adhesive 140 may be cured by application of UV energy. In other examples, the curable adhesive 140 may be a heat curable adhesive. Accordingly, with the first layer 110, the second layer 120 and the adhesive layers 130, 140 in the desired position, the curable adhesive 140 may be cured by application of thermal energy. The pressure sensitive adhesive 130 and the curable adhesive 140 are joined to provide adhesion of the first layer 110 to the second layer 120.

In various examples, the first layer 110 and the second layer 120 may have substantially different thermal expansion coefficients. For example, as noted above, the first layer 110 may be glass, with a linear thermal expansion coefficient of between about 4×10⁻⁶ m/m per degree Celsius and about 9×10⁻⁶ m/m per degree Celsius, and the second layer 110 may be molded plastic, with a linear thermal expansion coefficient of between about 50×10⁻⁶ m/m per degree Celsius and about 110×10⁻⁶ m/m per degree Celsius. Thus, with changing temperature, the first layer 110 and the second layer 120 may expand or contract at differing rates, resulting in possible separation of the two layers 110, 120. In the case of a glass layer adhered to a plastic layer, in addition to separation, changing temperature may cause the layers to bend to accommodate the different expansion rates, resulting in cracking or breaking of the glass layer.

In this regard, various examples described herein provide for the accommodation of varying temperature conditions. The combination of a pressure sensitive adhesive and a curable adhesive provide various features which improve the range of tolerable temperatures. For example, the pressure sensitive adhesive 130 allows at least some shearing as the first layer 110 and the second layer 120 expand or contract at different rates. In this regard, shearing may occur between the pressure sensitive adhesive 130 and the first layer 110, as well as between the pressure sensitive adhesive 130 and the curable adhesive 140. Thus, the first layer 110 and the second layer 120 may shear relative to one another during temperature changes.

Further, in some examples, the pressure sensitive adhesive 130 is selected with a low glass transition temperature, such as between about 0 degrees Celsius and about −50 degrees Celsius. Thus, at low temperatures, the pressure sensitive adhesive 130 may be rubbery and have elasticity to prevent or reduce the likelihood of cracking or breaking of the glass in the first layer 110. Further, in various examples, the curable adhesive 140 is selected such that its viscosity is sufficient to accommodate the substantially flat surface 112 of the first layer 110 and provide a sufficient seal between the first layer 110 and the second layer 120, the surface 122 of which may be non-flat. Thus, the viscosity of the curable adhesive 140 may allow the curable adhesive 140 to form a layer that is of non-uniform thickness to correspond to the space between the substantially flat surface 112 of the first layer 110 (or the substantially flat surface of the pressure sensitive adhesive 130) and the non-flat surface 122 of the second layer 120. In one example, the curable adhesive 140 has a viscosity of between about 1000 centipoise and about 25000 centipoise. In some cases, the non-uniform thickness of the curable adhesive 140 may be zero at a local region or point. At such regions, the pressure sensitive adhesive 130 may contact the second layer 120 and provide for shearing between the pressure sensitive adhesive 130 and the second layer 120.

In the example illustrated in FIG. 1, the example device 100 is provided with the pressure sensitive adhesive 130 applied to the substantially flat surface 112 of the first layer 110, and the curable adhesive 140 is applied to the non-flat surface 122 of the second layer 120. In other examples, the application of the adhesives 130, 140 may be reversed. For example, the pressure sensitive adhesive 130 may be applied to the non-flat surface 122 of the second layer, and the curable adhesive is applied to the substantially flat surface 112 of the first layer.

Referring now to FIGS. 2-4, an example apparatus 200 is illustrated at various stages of assembly. In various examples, the apparatus may be any of a variety of devices, such as imaging devices, for example. Referring first to FIG. 2, the example apparatus 200 is illustrated in a disassembled state. The example apparatus 200 is similar to the device 100 of FIG. 1 and includes a frame 210 and a cover layer 220. The frame 210 may be part of the body or housing of a larger device or system (e.g., imaging device). In various examples, the frame 210 may be formed of any of a variety of materials, such as plastic. In the example apparatus 200 of FIG. 2, the frame 210 has a surface 212 that is non-flat. For example, the surface 212 may be warped from manufacturing processes, for example.

In various examples, the cover layer 220 includes a substantially flat surface 222 and may be formed of any of a variety of materials. In one example, the cover layer 220 is formed of glass. As noted above, the materials of the different layers (e.g., the frame 210 and the cover layer 220) may have different thermal expansion coefficients. For example, the frame 210 may have a first thermal coefficient (e.g., about 50×10⁻⁶ m/m per degree Celsius for plastic), and the glass layer 220 may have a second thermal coefficient (e.g., 6×10⁻⁶ m/m per degree Celsius).

The example apparatus 200 is provided with a curable adhesive 230. In the example of FIG. 2, the curable adhesive 230 may be in fluid form when uncured. In this regard, FIG. 2 shows an amount of the fluid, uncured adhesive. As noted above, the curable adhesive 230 has a viscosity that is sufficient to allow the curable adhesive 230 to flow onto the surface 212 of the frame 210. In various examples, the curable adhesive 230 has a viscosity of between about 1000 centipoise and about 25000 centipoise. Similarly, the example apparatus 200 is provided with a pressure sensitive adhesive 240. In the example of FIG. 2, the pressure sensitive adhesive 240 may be a planar adhesive that may be adhered to the substantially flat surface 222 of the cover layer 220.

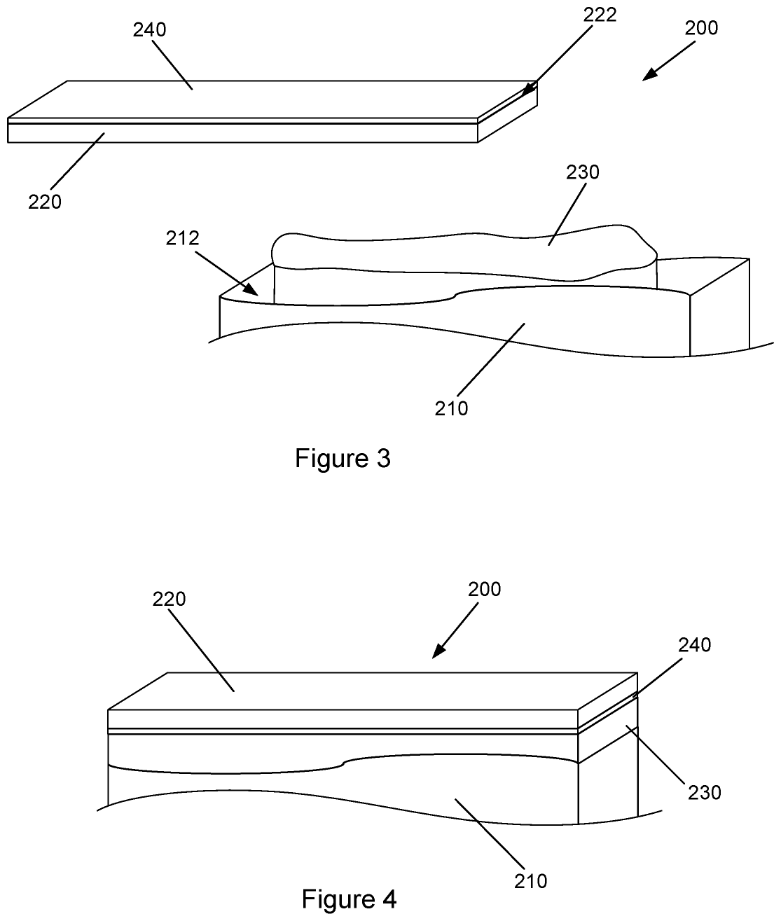

Referring now to FIG. 3, the adhesives 230, 240 are applied to respective surfaces 212, 222. In the example apparatus 200 of FIG. 3, the curable adhesive 230 is applied to the substantially non-flat surface 212 of the frame 210. In various examples, the viscosity of the curable adhesive 230 allows it to conform to the shape of the non-flat surface 212 of the frame 210, as illustrated in FIG. 3. Further, the pressure sensitive adhesive 240 is applied to the substantially flat surface 222 of the cover layer 220. In various examples, the pressure sensitive adhesive 240 may be a double-sided adhesive, with one side being used to adhere the pressure sensitive adhesive 240 to the substantially flat surface 222 of the cover layer 220.

Referring now to FIG. 4, the combination of the cover layer 220 and the pressure sensitive adhesive 240 is merged with the combination of the frame 210 and the curable adhesive 230. In this regard, the curable adhesive 230 and the pressure sensitive adhesive are joined to adhere the frame 210 to the cover layer 220. With the combination of the cover layer 220 and the pressure sensitive adhesive 240 pressed onto the combination of the frame 210 and the curable adhesive 230, the curable adhesive 230 is spread throughout the surface 212 of the frame 210. In this regard, the curable adhesive 230 and the pressure sensitive adhesive 240 may form a seal between the surfaces 212, 222. With the frame 210, the cover layer 220, the curable adhesive 230 and the pressure sensitive adhesive 240 in place, the curable adhesive 230 may be cured with the application of, for example, UV or thermal energy.

As noted above, various examples of the device 200 may accommodate greater temperature ranges and/or greater differences in expansion or contraction of the frame 210 and the cover layer 220. In this regard, a low glass transition temperature of the pressure-sensitive adhesive 240 provides improved performance at lower temperatures. Further, improved performance may also result from the shearing allowed by the pressure-sensitive adhesive 240.

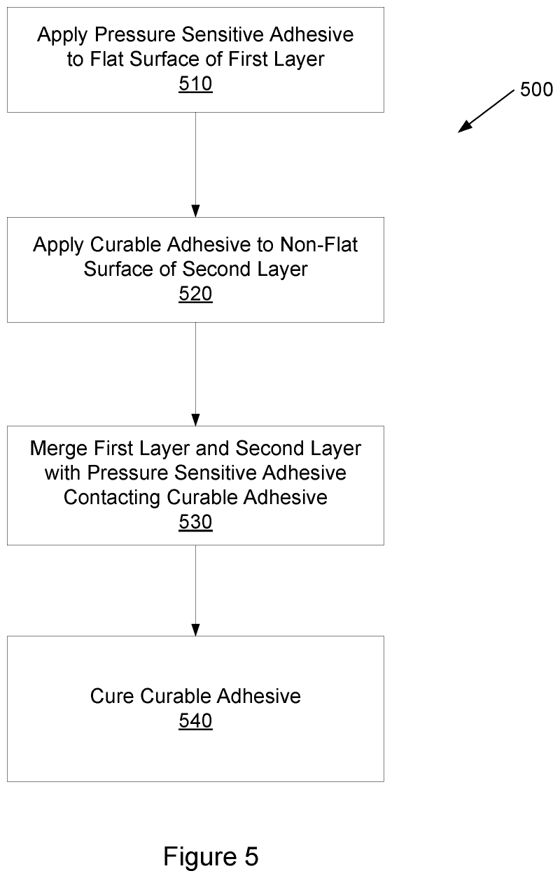

Referring now to FIG. 5, an example method for assembling an example apparatus is illustrated. The example method 500 includes a applying a pressure sensitive adhesive to a substantially flat surface of a first layer (block 510). As described above with reference to FIG. 3, the pressure sensitive adhesive 240 may be applied to the substantially flat surface 222 of the cover layer 220. The example method further includes applying a curable adhesive to a non-flat surface of a second layer (block 520). Again, as described above with reference to the example of FIG. 3, the curable adhesive 230 is applied to the non-flat surface 212 of the frame 210.

Referring again to FIG. 5, the example method 500 further includes merging the first layer and the second layer (block 530). In this regard, the pressure sensitive adhesive on the first layer is brought to contact with the curable adhesive on the second layer. For example, as described in the example of FIG. 4, the combination of the cover layer 220 and the pressure sensitive adhesive 240 is merged with the combination of the frame 210 and the curable adhesive 230, thus adhering the frame 210 to the cover layer 220. In the example method 500 of FIG. 5, the curable adhesive is then cured (block 540). Referring again to the example of FIG. 4 above, with the frame 210, the cover layer 220, the curable adhesive 230 and the pressure sensitive adhesive 240 in place, the curable adhesive 230 may be cured with the application of, for example, UV or thermal energy.

Thus, various examples described herein provide improved performance of a device with different layers adhered to one another. Various examples allow a device to accommodate a range of temperatures without the glass layer cracking. A pressure sensitive adhesive allows for shearing of the different layers, as well as providing a low glass transition temperature for improved performance at low temperatures. A curable adhesive is provided with a viscosity that allows the curable adhesive to conform to the pressure sensitive adhesive on one side and the layer (e.g., a molded layer) on the opposing side.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. A device, comprising:
a first layer having a first layer surface;
a second layer having a second layer surface;
a pressure sensitive adhesive applied to the first layer surface of the first layer; and
a curable adhesive applied to the second layer surface of the second layer,
wherein the curable adhesive and the pressure sensitive adhesive are joined to adhere the first layer to the second layer.

2. The device of claim 1, wherein the curable adhesive is at least one of a UV-curable adhesive or a heat-curable adhesive.

3. The device of claim 1, wherein the first layer is formed of glass and the second layer is formed of a molded plastic, and wherein the first layer surface of the first layer is substantially flat and the second layer surface of the second layer is non-flat.

4. The device of claim 1, wherein the first layer and the second layer have substantially different thermal expansion coefficients.

5. The device of claim 1, wherein the pressure sensitive adhesive has a glass transition temperature of between about 0 degrees Celsius and about −50 degrees Celsius.

6. The device of claim 1, wherein the curable adhesive has a viscosity of between about 1000 centipoise and about 25000 centipoise.

7. An apparatus, comprising:
a frame having a non-flat surface, the non-flat surface having a first thermal expansion coefficient;
a cover layer having at least one substantially flat surface and having a second thermal expansion coefficient, the first thermal expansion coefficient and the second thermal expansion coefficient being different;
a curable adhesive applied to the non-flat surface of the frame; and
a pressure sensitive adhesive applied to the substantially flat surface of the cover layer,
wherein the curable adhesive and the pressure sensitive adhesive are joined to adhere the frame to the cover layer.

8. The apparatus of claim 7, wherein the curable adhesive is at least one of a UV-curable adhesive or a heat-curable adhesive.

9. The apparatus of claim 7, wherein the frame is formed of a molded plastic.

10. The apparatus of claim 7, wherein the cover layer is formed of glass.

11. The apparatus of claim 10, wherein the pressure sensitive adhesive has a glass transition temperature of between about 0 degrees Celsius and about −5 degrees Celsius.

12. The apparatus of claim 10, wherein the curable adhesive has a viscosity of between about 1000 centipoise and about 25000 centipoise.

13. A method, comprising:
applying a pressure sensitive adhesive to a substantially flat surface of a first layer;
applying a curable adhesive to a non-flat surface of a second layer;
merging the first layer and the second layer with the pressure sensitive adhesive on the first layer contacting the curable adhesive on the second layer; and
curing the curable adhesive.

14. The method of claim 13, wherein the curable adhesive is at least one of a UV-curable adhesive or a heat-curable adhesive.

15. The method of claim 13, wherein the first layer and the second layer have substantially different thermal expansion coefficients.
